(19) United States
(12) Patent Application Publication
(10) Pub. No.: US 2024/0351538 A1
(43) Pub. Date: Oct. 24, 2024

(54) STEER-BY-WIRE STEERING DEVICE

(71) Applicant: HL MANDO CORPORATION, Pyeongtaek-si (KR)

(72) Inventor: Sungjune MOON, Seoul (KR)

(73) Assignee: HL MANDO CORPORATION, Pyeongtaek-si (KR)

(21) Appl. No.: 18/384,781

(22) Filed: Oct. 27, 2023

(30) Foreign Application Priority Data
Apr. 18, 2023 (KR) 10-2023-0050831

(51) Int. Cl. B60R 16/027; B62D 1/181; B62D 1/187; H02G 11/00

(52) U.S. Cl. CPC B60R 16/027; B62D 1/181; B62D 1/187; H02G 11/00

(57) ABSTRACT

According to the present embodiments, it is possible to prevent, e.g., friction, interference, or jam which may occur during telescoping between the wire and the surrounding components to prevent damage to the wire or an open circuit, remove the component for supporting the wire, save components, and simplify the assembly process.

### CROSS-REFERENCE TO RELATED APPLICATION

This application claims priority from Korean Patent Application No. 10-2023-0050831, filed on Apr. 18, 2023, which is hereby incorporated by reference for all purposes as if fully set forth herein.

### BACKGROUND

### Field

The present embodiments relate to a wire assembly and a vehicle steering device including the same and, more specifically, to a wire assembly that may prevent, e.g., friction, interference, or jam which may occur during telescoping between the wire connecting electronic components in the steering column and the surrounding components to prevent damage to the wire or an open circuit, remove the component for supporting the wire on the steering column, save components, and simplify the assembly process and a vehicle steering device including the wire assembly.

### Description of Related Art

A vehicle steering device is a device for changing the traveling direction of the vehicle as intended by the user and turns the left and right wheels of the vehicle to the left or right to allow the vehicle to travel in the direction desired by the driver.

The steering device includes a steering column for receiving the steering shaft connected with the steering wheel. Typically, the steering column has the telescoping and tilting functionality for adjusting the position of the steering wheel to fit the driver's height and body shape.

Recently, autonomous vehicles are advancing rapidly. Autonomous vehicles provide various features for enabling the driver to do various activities in auto driving mode. In other words, the steering column is equipped with various electronic components, e.g., sensors, for providing various convenient functions to the driver, as well as the telescoping and tilt functions, and wires for communication and control between electronic components.

However, in the autonomous vehicle, since the steering wheel takes up a lot of space in the driver's seat and interferes with the driver's movement, it is required to store the steering wheel in the vehicle body in autonomous mode and withdraw the steering wheel from the vehicle body in manual mode.

Therefore, the telescoping stroke needs to be significantly larger than the conventional one to store the steering wheel in the vehicle body or withdraw the steering wheel from the vehicle body. As the telescoping stroke increases, the extension/contraction of the steering column is significantly increased, so that the wire connecting various electronic components is lengthened as well.

However, the increase in the length of the wire may cause such issues as friction, interference, or jam between the wire and the surrounding components when the steering column extends or contracts, with the result of possible wire damage or an open circuit which may threaten the driver's safety.

### BRIEF SUMMARY

Conceived in the foregoing background, the present embodiments relate to a wire assembly that may prevent, e.g., friction, interference, or jam which may occur during telescoping between the wire to prevent damage to the wire or an open circuit, remove the component for supporting the wire, save components, and simplify the assembly process and a vehicle steering device including the wire assembly.

According to the present embodiments, there may be provided a wire assembly comprising a wire portion including a first rigid portion and a second rigid portion, wherein a bending rigidity of the first rigid portion is larger than a bending rigidity of the second rigid portion.

According to the present embodiments, there may be provided a wire assembly comprising a wire and a wire portion receiving at least a portion of the wire and including a reinforcing member reinforcing a bending rigidity of the wire.

According to the present embodiments, there may be provided a vehicle steering device comprising a steering column including a wire assembly comprising a wire portion including a first rigid portion and a second rigid portion, wherein a bending rigidity of the first rigid portion is larger than a bending rigidity of the second rigid portion or a wire assembly comprising a wire and a wire portion receiving at least a portion of the wire and including a reinforcing member reinforcing a bending rigidity of the wire.

According to the present embodiments, it is possible to prevent, e.g., friction, interference, or jam which may occur during telescoping between the wire and the surrounding components to prevent damage to the wire or an open circuit, remove the component for supporting the wire, save components, and simplify the assembly process.

### DESCRIPTION OF DRAWINGS

The above and other objects, features, and advantages of the disclosure will be more clearly understood from the following detailed description, taken in conjunction with the accompanying drawings, in which:

FIG. 1 is a side view illustrating a wire assembly according to the present embodiments;

FIG. 2 is a side view illustrating a wire assembly according to the present embodiments;

FIG. 3 is a side view illustrating a wire assembly according to the present embodiments;

FIG. 4 is a side view illustrating a wire assembly according to the present embodiments;

FIG. 5 is a view illustrating comparison between a modified state of a wire assembly according to the present embodiments and a conventional wire assembly;

FIG. 6 is a side view illustrating a wire assembly according to the present embodiments;

FIG. 7 is a side view illustrating a wire assembly according to the present embodiments;

FIG. 8 is a side view illustrating a wire assembly according to the present embodiments;

FIG. 9 is a side view illustrating a portion of a wire assembly according to the present embodiments;

FIG. 10 is a side view illustrating a portion of a wire assembly according to the present embodiments;

FIG. 11 is a perspective view illustrating a portion of a wire assembly according to the present embodiments;

FIG. 12 is a cross-sectional view illustrating a portion of a wire assembly according to the present embodiments;

FIG. 13 is a perspective view illustrating a steering device of a vehicle according to the present embodiments;

FIG. 14 is a perspective view illustrating a steering device of a vehicle according to the present embodiments; and

FIG. 15 is an exploded perspective view illustrating a steering device of a vehicle according to the present embodiments.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

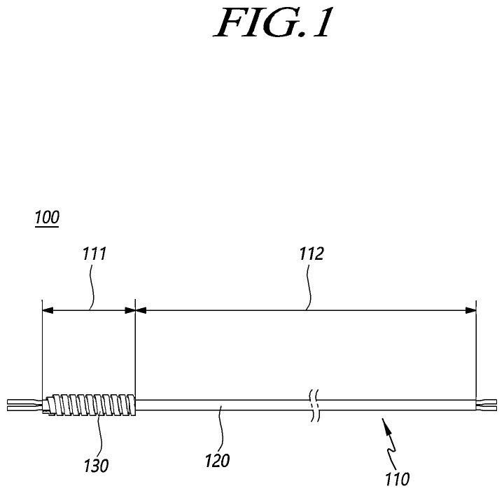

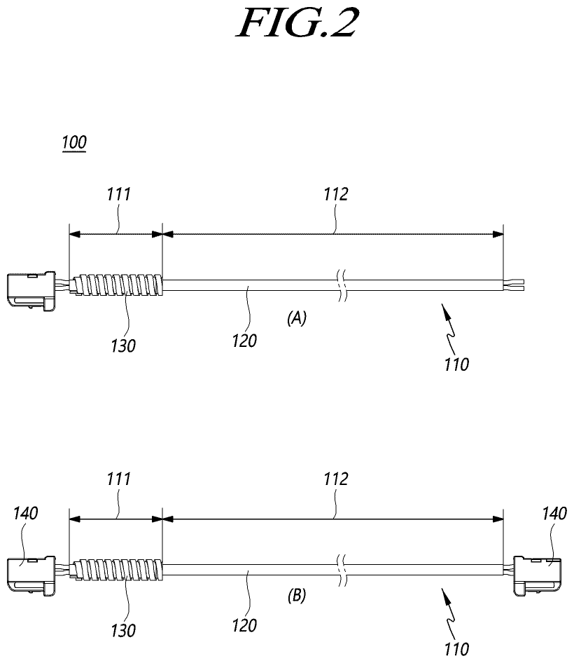

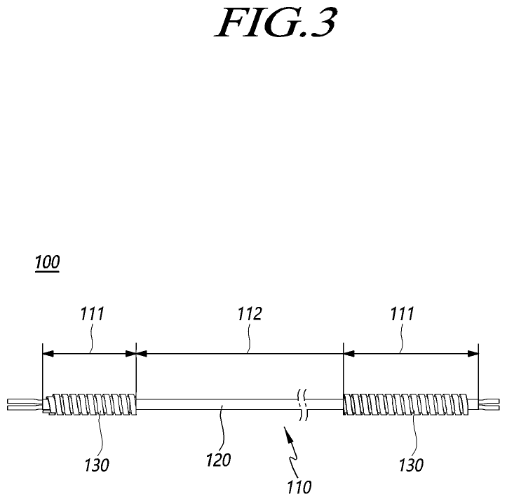

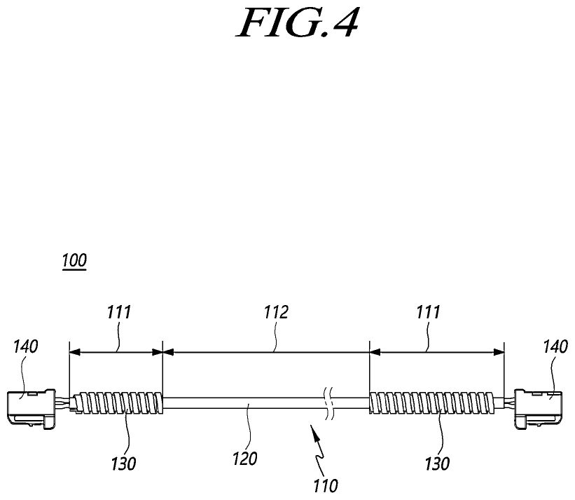

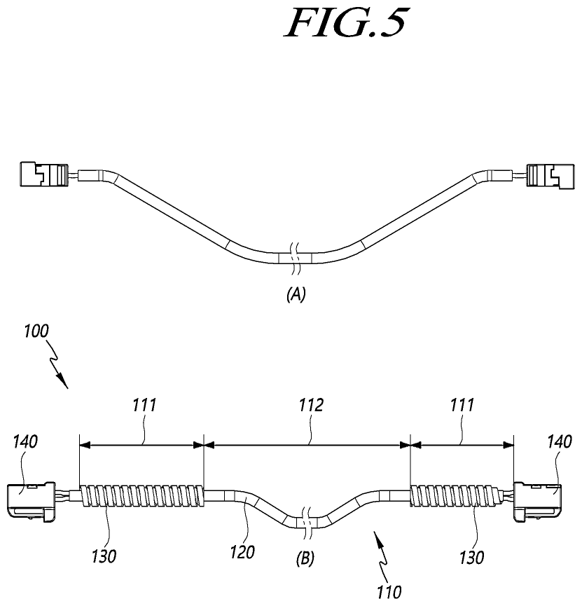

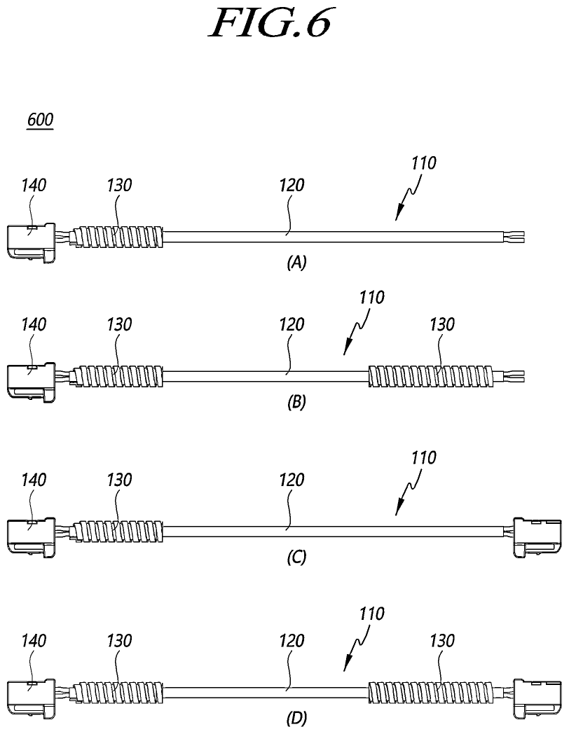

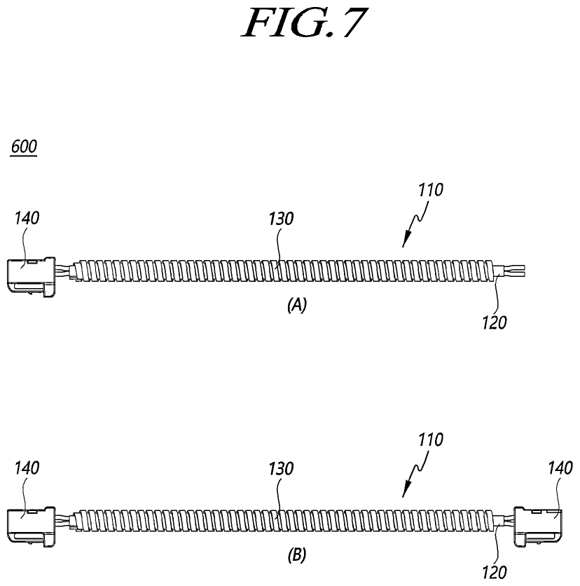

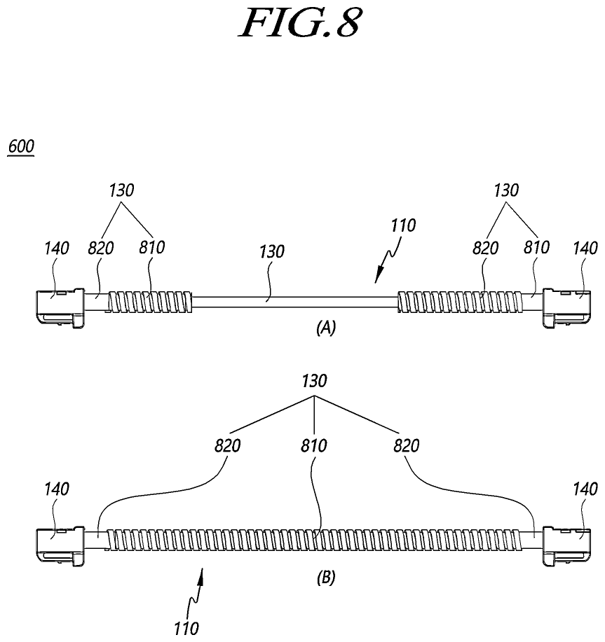

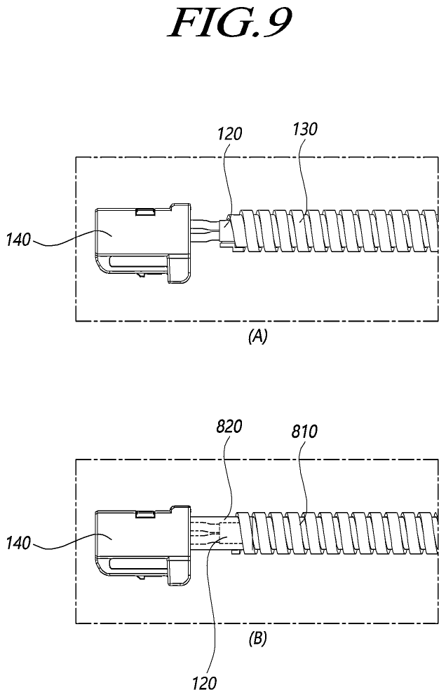

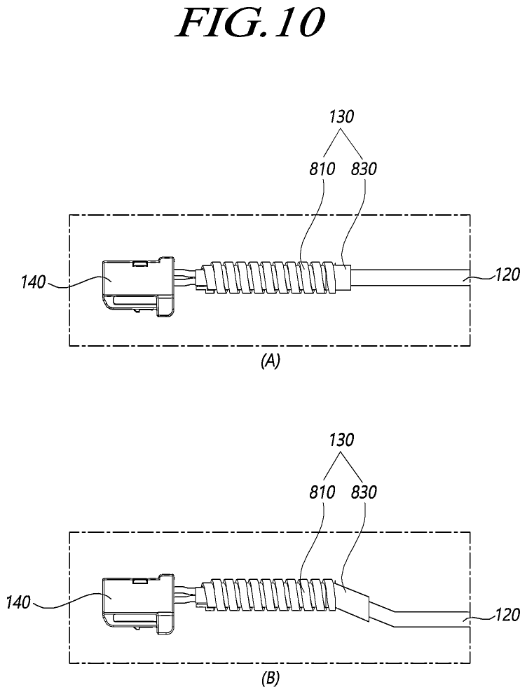

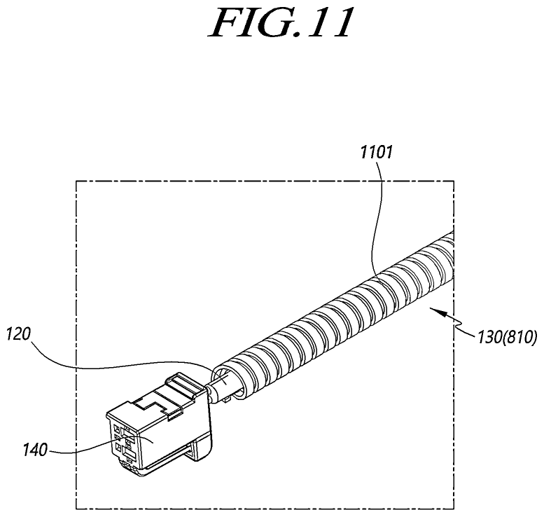

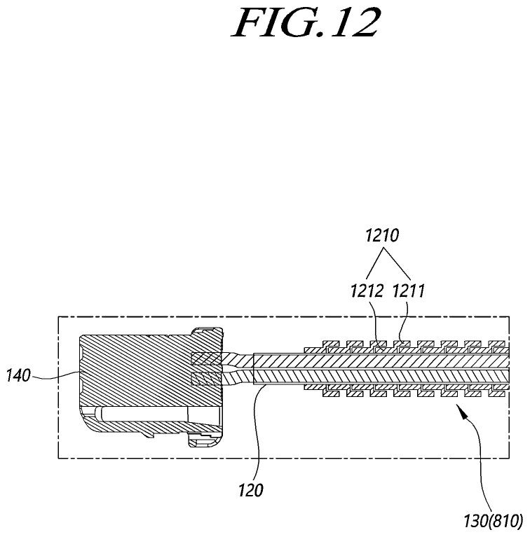

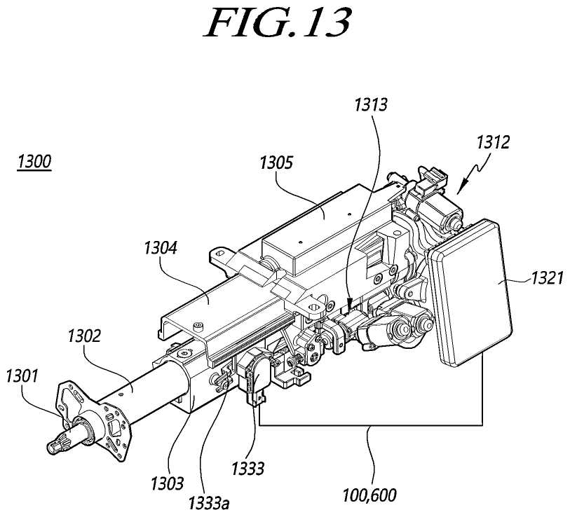

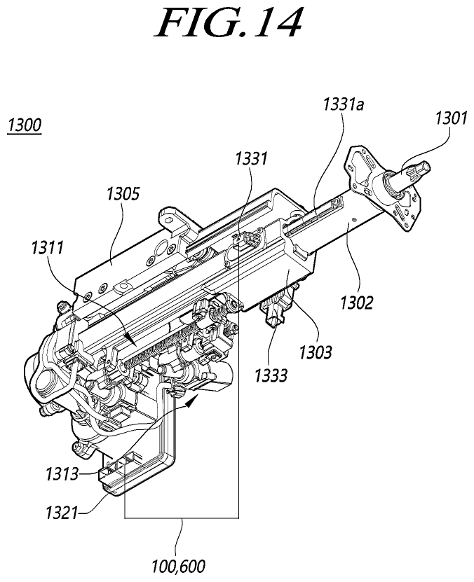

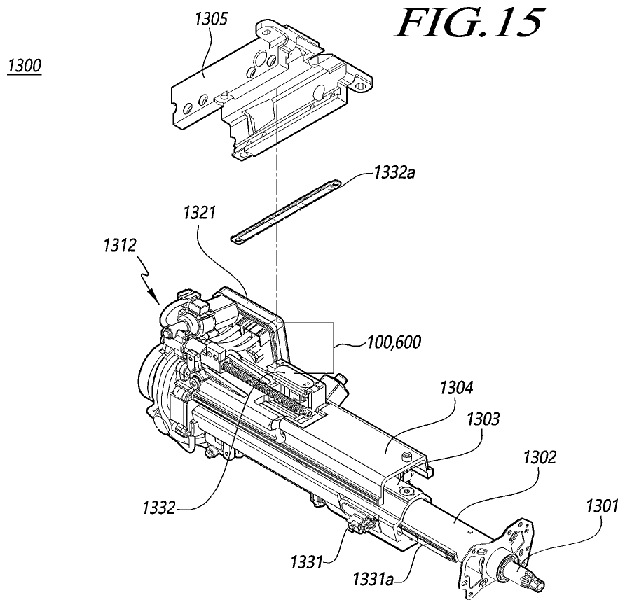

FIG. 1 is a side view illustrating a wire assembly according to the present embodiments. FIG. 2 is a side view illustrating a wire assembly according to the present embodiments. FIG. 3 is a side view illustrating a wire assembly according to the present embodiments. FIG. 4 is a side view illustrating a wire assembly according to the present embodiments. FIG. 5 is a view illustrating comparison between a modified state of a wire assembly according to the present embodiments and a conventional wire assembly. FIG. 6 is a side view illustrating a wire assembly according to the present embodiments. FIG. 7 is a side view illustrating a wire assembly according to the present embodiments. FIG. 8 is a side view illustrating a wire assembly according to the present embodiments. FIG. 9 is a side view illustrating a portion of a wire assembly according to the present embodiments. FIG. 10 is a side view illustrating a portion of a wire assembly according to the present embodiments. FIG. 11 is a perspective view illustrating a portion of a wire assembly according to the present embodiments. FIG. 12 is a cross-sectional view illustrating a portion of a wire assembly according to the present embodiments. FIG. 13 is a perspective view illustrating a steering device of a vehicle according to the present embodiments. FIG. 14 is a perspective view illustrating a steering device of a vehicle according to the present embodiments. FIG. 15 is an exploded perspective view illustrating a steering device of a vehicle according to the present embodiments.

A wire assembly 100 according to the present embodiments includes a first rigid portion 111 and a second rigid portion 112. The bending rigidity of the first rigid portion 111 is larger than the bending rigidity of the second rigid portion 112. In other words, the wire assembly 100 according to the present embodiments includes a wire portion 110. The wire portion 110 includes a first rigid portion 111 and a second rigid portion 112. The first rigid portion 111 has a larger bending rigidity than the second rigid portion 112.

Referring to FIG. 1, the wire portion 110 of the wire assembly 100 according to the present embodiments includes the first rigid portion 111 and the second rigid portion 112. Two opposite ends of the wire portion 110 are connected to electronic components provided in, e.g., the steering column of the vehicle, and the first rigid portion 111 and the second rigid portion 112 are formed between the two opposite ends. FIG. 1 illustrates an embodiment in which an end portion of the wire portion 110 is formed as the first rigid portion 111, and the rest is formed as the second rigid portion 112.

The bending rigidity of the first rigid portion 111 is larger than the bending rigidity of the second rigid portion 112. In other words, when a predetermined bending moment is applied to the wire portion 110, the bending amount of the first rigid portion 111 is smaller than the bending amount of the second rigid portion 112. The difference in bending rigidity between the first rigid portion 111 and the second rigid portion 112 leads to a local stiffness difference in the wire portion 110. When a bending moment is applied to the wire assembly according to the present embodiments, a large bending amount may be generated in a specific portion while a small bending amount may be generated in another specific portion. The bending moment applied to the wire portion 110 may be generated by, e.g., movement of at least one of two opposite ends of the wire portion 110 due to external driving force (e.g., when telescoping is performed in the vehicle steering device), the own weight of the wire portion, or external impact, but the type and cause of generation are not limited.

Referring to FIG. 5, (A) of FIG. 5 illustrates a state in which a bending moment is applied to a conventional wire structure having a predetermined bending rigidity without a difference in rigidity from one end to the other, and (B) of FIG. 5 illustrates a state in which a bending moment is applied to a wire assembly according to the present embodiments. In other words, as shown in (A) of FIG. 5, the conventional wire structure is overall uniformly deformed by the bending moment. However, in the wire assembly according to the present embodiments as shown in (B) of FIG. 5, the bending amount of a specific portion may be set to be smaller than the bending amount of another portion due to the difference in rigidity between the first rigid portion 111 and the second rigid portion 112 and/or rigidity reinforcement by a reinforcing member 130.

The path between two opposite ends of the wire portion 110 may be adjusted as desired by leading to a change in the shape of the wire assembly 100 according to the present embodiments, b using the local stiffness difference and the resultant bending amount difference.

For example, when the distance between two electronic components connected by the wire assembly 100 according to the present embodiments increases or decreases as the steering column extends or contracts, if a specific portion of the wire portion 110 is positioned adjacent to its surrounding component to likely cause interference, the specific portion may be formed of the first rigid portion 111, and another portion may be formed of the second rigid portion 112. Accordingly, despite extension/contraction of the steering column, the first rigid portion 111 is relatively less deformed than the second rigid portion 112 due to its high bending rigidity, causing no or reduced interference or friction to the surrounding components.

Further, for example, in the vehicle steering device, the wire is conventionally coupled to the steering column using various clips to prevent interference with the surrounding components and support the weight of the wire. However, such a supporting structure is structurally unstable and may not effectively block interference between the wire and the surrounding component and causes an increase in the numbers of components and assembly processes. However, according to the present embodiments, such wire supporting components, e.g., clips, are unnecessary, and the numbers of components and assembly processes are reduced.

The difference in rigidity between the first rigid portion 111 and the second rigid portion 112 may be implemented through a reinforcing member 130 described below in detail. In other words, the first rigid portion 111 may include the wire 120 and the reinforcing member 130 receiving the wire 120. The second rigid portion 112 may include only the wire 120, but may not include the reinforcing member 130. The reinforcing member 130 may reinforce the bending rigidity while receiving the wire 120, implementing a difference in bending rigidity between the portion with the reinforcing member 130 and the portion without the reinforcing member 130. Or, the difference in rigidity between the first rigid portion 111 and the second rigid portion 112 may also be implemented through a difference in the material of the wire 120. For example, a difference in bending rigidity may be implemented by forming the coat of the first rigid portion 111 and the coat of the second rigid portion 112 with different materials. Although the drawings illustrate only an embodiment in which a difference in bending rigidity is implemented through the reinforcing member 130, the disclosure is not limited thereto.

Referring to FIG. 2, the wire assembly 100 according to the present embodiments further includes a connector portion 140 connected to at least one of two opposite ends of the wire portion 110. (A) of FIG. 2 illustrates an embodiment in which the connector portion 140 is connected to only one end of the wire portion 110, and (B) of FIG. 2 illustrates an embodiment in which connector portions 140 are connected to both the two opposite ends of the wire portion 110. In other words, an end portion of the wire portion 110 may be connected to an electronic component directly or via the connector portion 140.

According to an embodiment, the first rigid portion 111 may be provided at an end portion of the wire portion 110. The first rigid portion 111 may be provided at the end portion of the wire portion 110, increasing the bending rigidity of the portion of the wire portion 110 connected to the electronic component. In other words, the bending rigidity of the end portion of the wire portion 110, connected to the electronic component may be reinforced by the first rigid portion 111, and the amount of deformation by the bending moment is small, so that interference and friction with the surrounding component may be reduced or prevented. In other words, according to an embodiment, the connector portion 140 connected to an end of the wire portion 110 may be further included, and the first rigid portion 111 may be positioned at an end portion of the wire portion 110.

According to an embodiment, the wire portion 110 may include a plurality of first reinforcing portions 111. In other words, the wire portion 110 may have a plurality of first reinforcing portions 111 that may be spaced apart from each other. The second rigid portion 112 is formed between the first rigid portions 111 spaced apart.

Referring to FIG. 3, the first rigid portions 111 may be provided at two opposite end portions of the wire portion 110, and the second rigid portion 112 may be provided between the first rigid portions 111. The first rigid portions 111 provided at the two opposite end portions may have the same length, or one thereof may have a length larger or smaller than that of the other. As the first rigid portions 111 are provided at two opposite end portions, when a bending moment is applied, the bending amount of the wire portion 110 is smaller at the two opposite end portions and is larger therebetween. Accordingly, the amount of deformation by the bending moment at the two opposite end portions of the wire portion 110 connected to the electronic component is small, reducing or preventing interference or friction with the surrounding components. In other words, referring to FIG. 4, the wire assembly 100 according to the present embodiments may further include a pair of connector portions 140 respectively connected to two opposite end portions of the wire portion 110, and the first rigid portions 111 may be provided at the two opposite end portions of the wire portion 110.

As such, as the path of deformation of the wire portion 110 when a bending moment is applied is adjusted by the difference in rigidity between the first rigid portion 111 and the second rigid portion 112, it is possible to prevent friction, interference, or jam with the surrounding components and resultant damage or an open circuit.

According to the present embodiments, there may be provided a wire assembly 100, comprising a wire 120 and a wire portion 110 receiving at least a portion of the wire 120 and including a reinforcing member 130 reinforcing a bending rigidity of the wire 120. The same features as those of the above-described embodiments will be briefly described, and the description focuses primarily on differences.

Referring to FIGS. 6 and 7, a wire assembly 600 according to the present embodiments includes a wire 120 and a reinforcing member 130. The reinforcing member 130 has a form of a body portion having a spiral recess or a body portion in which a plurality of segments are connected, includes at least a portion of the wire 120, and reinforces the bending rigidity of the wire 120 as described below in detail. In other words, according to an embodiment, the reinforcing member 130 may receive a portion of the wire 120 while not receiving the rest. Accordingly, the bending rigidity of the portion (i.e., the first rigid portion 111) of the wire portion 110 including the wire 120 received in the reinforcing member 130 is larger than the bending rigidity of the rest (i.e., the second rigid portion 112). Or, according to an embodiment, the reinforcing member 130 may receive the whole wire 120. Therefore, the bending rigidity of the wire portion 110 is overall reinforced.

According to an embodiment, the wire assembly 600 according to the present embodiments further includes a connector portion 140 connected to at least one of two opposite ends of the wire 120.

Referring to (A) of FIG. 6, the connector portion 140 may be connected to one end of the wire 120, and the reinforcing member 130 may receive one end portion of the wire 120.

Referring to (B) of FIG. 6, the connector portion 140 may be connected to one end of the wire 120, and the reinforcing member 130 may receive one end portion and the other end portion of the wire 120. In other words, there may be provided a plurality of reinforcing members 130 spaced apart from each other, and a plurality of portions of the wire 120 received in the plurality of reinforcing members 130 may have a larger bending rigidity than the rest.

Referring to (C) of FIG. 6, the connector portions 140 may be connected to two opposite ends of the wire 120, and the reinforcing member 130 may receive one end portion of the wire 120.

Referring to (D) of FIG. 6, the connector portions 140 may be connected to two opposite ends of the wire 120, and the reinforcing member 130 may receive one end portion and the other end portion of the wire 120.

Referring to (A) of FIG. 7, the connector portion 140 may be connected to one end of the wire 120, and the reinforcing member 130 may receive the whole wire 120.

Referring to (B) of FIG. 7, the connector portions 140 may be connected to two opposite ends of the wire 120, and the reinforcing member 130 may receive the whole wire 120.

Referring to FIG. 8, the reinforcing member 130 may include a body portion 810 receiving the wire 120 and a connecting portion 820 connecting an end portion of the body portion 810 and the connector portion 140. The body portion 810 is hollow to receive the wire 120 thereinside and reinforce the rigidity of the wire 120. The connecting portion 820 connects an end portion of the body portion 810 and the connector portion 140 not to expose the wire 120 between the end portion of the body portion 810 and the connector portion 140.

(A) of FIG. 9 illustrates a state in which the wire 120 is exposed between the connector portion 140 and the body portion 810, and (B) of FIG. 9 illustrates a state in which the wire 120 is covered between the connector portion 140 and the body portion 810 by the connecting portion 820. The connected portion of the connector portion 140 and the wire 120 may be protected by the connecting portion 820.

Referring to FIG. 10, the reinforcing member 130 may include a body portion 810 receiving the wire 120 and a guide portion 830 extending from an end portion of the body portion 810 and guiding the wire 120 drawn out of the end portion of the body portion 810. The guide portion 830 guides the portion, which is not received in the body portion 810 of the wire 120, to be naturally drawn out of the portion received in the body portion 810. In other words, the guide portion 830 may give directivity to the wire 120 provided outside the body portion 810. (A) of FIG. 10 illustrates a state in which the wire 120 is guided in the direction in which the body portion 810 is formed (the right direction in the figure) by the guide portion 830. According to an embodiment, the guide portion 830 may be bent from an end portion of the body portion 810. (B) of FIG. 10 illustrates an embodiment in which the guide portion 830 is bent upward/downward, in the figure, from the end portion of the body portion 810. The wire 120 drawn out of the body portion 810 is naturally guided downward along the guide portion 830. It is possible to minimize interference, friction, or jam with the surrounding components of the wire assembly 600 according to the present embodiments by properly setting the direction of the guide portion 830. Although FIGS. 8 to 10 illustrate an embodiment in which only one of the connecting portion 820 and the guide portion 830 is provided in the body portion 810, the connecting portion 820 and the guide portion 830 both may be provided.

Referring to FIG. 11, the reinforcing member 130 may include the body portion 810 that is formed to be hollow to receive the wire and has a spiral groove 1101 formed in the outer circumferential surface thereof. In other words, the body portion 810 is hollow and may have the spiral groove 1101 formed in the outer circumferential surface thereof. By the groove 1101, the hollow body portion 810 may be flexibly bent by bending moment. However, to reinforce the bending rigidity of the wire 120, its bending rigidity is larger than that of the wire 120. The connecting portion 820 and/or the guide portion 830 may be integrally formed or attached to an end portion of the body portion 810 having the groove 1101.

Referring to FIG. 12, the reinforcing member 130 may be formed in a ring shape and may be formed as a plurality of segments 1210 penetrated by the wire 120 are connected to each other. Each segment 1210 is formed in a ring shape and is positioned on the outer circumference of the wire 120. Each segment 1210 is coupled to the adjacent segment 1210 to be bent at a predetermined angle and, as the bending angle between segments 1210 is accrued, the bending amount of the overall reinforcing member 130 is formed. The segments 1210 are coupled to have a predetermined resistance to the bending moment, forming the bending rigidity of the overall reinforcing member 130. Thus, the reinforcing member 130 may reinforce the bending rigidity of the wire 120. The connector portion 140 and/or the guide portion 830 may be integrally formed or attached to the first or last segment among the segments 1210 forming the body portion 810.

According to an embodiment, each segment 1210 may include a large diameter portion 1211 and a small diameter portion 1212, and each segment 1210 may be connected while the large diameter portion 1211 is inserted into the small diameter portion 1212 between the adjacent segments. In other words, the small diameter portion 1212 is inserted into the large diameter portion 1211, and a plurality of segments 1210 are connected, forming the reinforcing member 130. Resistance to bending moment between segments 1210 may be formed by friction between the large diameter portion 1211 and the small diameter portion 1212.

As such, as the path of deformation of the wire portion 110 when a bending moment is applied is adjusted by reinforcing the bending rigidity of the wire 120 using the reinforcing member 130, it is possible to prevent friction, interference, or jam with the surrounding components and resultant damage or an open circuit.

The wire assembly 100 or 600 according to the present embodiments may be provided in the vehicle to connect electronic components of the vehicle. Specifically, the wire assembly 100 or 600 according to the present embodiments may connect electronic components provided in the steering column of the vehicle. According to the present embodiments, there may be provided a vehicle steering device including a steering column 1300 including the wire assembly 100 or 600.

According to the present embodiments, there may be provided a vehicle steering device including a steering column 1300 including the wire assembly 100 according to the present embodiments or the wire assembly 600 according to the present embodiments. The wire assembly 100 according to the present embodiments or the wire assembly 600 according to the present embodiments may connect electronic components provided in the steering column 1300 of the vehicle steering device according to the present embodiments. Therefore, when the steering column 1300 extends or contracts, interference, friction, or jam with the surrounding components of the wire assembly 100 or 600 may be reduced or prevented.

Referring to FIGS. 13 to 15, the steering column 1300 may include an upper tube 1302 receiving a steering shaft 1301, a lower tube 1303 receiving the upper tube 1302, a movable bracket 1304 to which the lower tube 1303 is rotatably coupled, a fixed bracket 1304 fixed to a vehicle body and to which the movable bracket 1304 is coupled to be axially movable, a first driver 1311 for axially sliding the upper tube 1302 with respect to the lower tube 1303, a second driver 1312 for axially sliding the lower tube 1303 with respect to the fixed bracket 1305, a third driver 1313 for tilting the lower tube 1303 with respect to the movable bracket 1304, and a controller 1321 controlling the first driver 1311, the second driver 1312, and the third driver 1313.

The upper tube 1302 receiving the steering shaft 1301 is provided to be slidable with respect to the lower tube 1303 and is slid by the first driver 1311. The steering column 1300 is telescoped by the slide of the upper tube 1302.

The lower tube 1303 is rotatably coupled to the movable bracket 1304 and is axially fixed. The movable bracket 1304 is coupled to be slidable with respect to the fixed bracket 1305 and is slid by the second driver 1312. The movable bracket 1304 and the fixed bracket 1305 may be coupled in a rail structure formed along the axial direction. The slide of the upper tube 1302 with respect to the lower tube 1303 and the slide of the movable bracket 1304 with respect to the fixed bracket 1305 may be simultaneously performed to perform the storing or withdrawing operation, so-called stowing.

The lower tube 1303 is coupled to be tiltable with respect to the movable bracket 1304 and is tilted by the third driver 1313. The movable bracket 1304 is axially movable with respect to the fixed bracket 1305 while being fixed in the tilting direction.

The controller 1321 controls the first driver 1311 to the third driver 1313 to perform the telescoping, stowing, and tilting of the steering column. In order for the controller 1321 to control the first driver 1311 to the third driver 1313 to perform the operation of the steering column, the steering column may include a first sensor 1331 for sensing the position of the upper tube 1302 with respect to the lower tube 1303, a second sensor 1332 for sensing the position of the lower tube 1303 with respect to the fixed bracket 1305, and a third sensor 1333 for sensing the angle of the lower tube 1303 from the movable bracket 1304. The wire assembly 100 or 600 according to the present embodiments may connect the controller 1321 and the first sensor 1331 to the third sensor 1333 to transmit the information measured by the first sensor 1331 to the third sensor 1333 to the controller 1321.

In other words, according to an embodiment, the vehicle steering device according to the present embodiments may further include the first sensor 1331 for sensing the axial position of the upper tube 1302 with respect to the lower tube 1303, and the wire assembly 100 or 600 according to the present embodiments may connect the first sensor 1331 and the controller 1321. The first sensor 1331 is coupled to the lower tube 1303 and fixed, and a magnet 1331a is coupled to the upper tube 1302 and fixed. The first sensor 1331 may sense the position of the upper tube 1302 from a change in the magnetic flux generated by the movement of the upper tube 1302 with respect to the lower tube 1303.

Further, according to an embodiment, the vehicle steering device according to the present embodiments may further include the second sensor 1332 for sensing the axial position of the lower tube 1303 with respect to the fixed bracket 1305, and the wire assembly 100 or 600 according to the present embodiments may connect the second sensor 1332 and the controller 1321. The second sensor 1332 is coupled to the movable bracket 1304 and fixed, and a magnet 1332a is coupled to the fixed bracket 1305 and fixed. The position of the lower tube 1303 may be sensed from a change in the magnetic flux generated according to movement to the movable bracket 1304.

Further, according to an embodiment, the vehicle steering device according to the present embodiments may further include the third sensor 1333 for sensing the angle of the lower tube 1303 from the movable bracket 1304, and the wire assembly 100 or 600 according to the present embodiments may connect the third sensor 1333 and the controller 1321. The third sensor 1333 may be coupled to the movable bracket 1304 and fixed and may sense the tilting angle of the lower tube 1303 from the rotating angle of a load 1333a having one end coupled to the lower tube 1303 and the other end coupled to the movable bracket 1304.

As the first sensor 1331 to the third sensor 1333 are connected with the controller 1321 by the wire assembly 100 or 600 according to the present embodiments, friction, interference, or jam with the surrounding components during telescoping, stowing, and tilting may be reduced or prevented.

By the so-shaped wire assembly and the vehicle steering device including the same, it is possible to prevent, e.g., friction, interference, or jam which may occur during telescoping between the wire and the surrounding components to prevent damage to the wire or an open circuit, remove the component for supporting the wire, save components, and simplify the assembly process.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims. The scope of protection of the disclosure should be construed based on the following claims, and all technical ideas within the scope of equivalents thereof should be construed as being included within the scope of the disclosure.

What is claimed:

1. A wire assembly, comprising a wire portion including a first rigid portion and a second rigid portion, wherein a bending rigidity of the first rigid portion is larger than a bending rigidity of the second rigid portion.

2. The wire assembly of claim 1, further comprising a connector portion connected to at least one of two opposite ends of the wire portion.

3. The wire assembly of claim 1, wherein the first rigid portion is provided at an end portion of the wire portion.

4. The wire assembly of claim 1, further comprising a connector portion connected to an end of the wire portion,
wherein the first rigid portion is positioned at an end portion of the wire portion.

5. The wire assembly of claim 1, wherein the wire portion includes a plurality of first rigid portions.

6. The wire assembly of claim 5, wherein the first rigid portions are provided at two opposite end portions of the wire portion, and the second rigid portion is provided between the first rigid portions.

7. The wire assembly of claim 1, further comprising a pair of connector portions respectively connected to two opposite end portions of the wire portion,
wherein first rigid portions are provided at the two opposite end portions of the wire portion.

8. A wire assembly, comprising a wire and a wire portion receiving at least a portion of the wire and including a reinforcing member reinforcing a bending rigidity of the wire.

9. The wire assembly of claim 8, further comprising a connector portion connected to at least one of two opposite ends of the wire.

10. The wire assembly of claim 9, wherein the reinforcing member includes a body portion receiving the wire and a connecting portion connecting an end portion of the body portion and the connector portion.

11. The wire assembly of claim 8, wherein the reinforcing member includes a body portion receiving the wire and a guide portion extending from an end portion of the body portion and guiding the wire drawn out of an end portion of the body portion.

12. The wire assembly of claim 11, wherein the guide portion is bent from an end portion of the body portion.

13. The wire assembly of claim 8, wherein the reinforcing member includes a body portion that is formed to be hollow to receive the wire and has a spiral groove formed in an outer circumferential surface thereof.

14. The wire assembly of claim 8, wherein the reinforcing member includes a body portion that is formed in a ring shape and is formed as a plurality of segments penetrated by the wire are connected to each other.

15. The wire assembly of claim 14, wherein each of the plurality of segments includes a large diameter portion and a small diameter portion, and wherein each segment is connected as the small diameter portion is inserted into the large diameter portion between adjacent segments.

16. A vehicle steering device comprising a steering column including the wire assembly of claim 1.

17. The vehicle steering device of claim 16, wherein the steering column includes an upper tube receiving a steering shaft, a lower tube receiving the upper tube, a fixed bracket fixed to a vehicle body and coupled with the lower tube, a first driver for axially sliding the upper tube with respect to the lower tube, a second driver for axially sliding the lower tube with respect to the fixed bracket, a third driver for tilting the lower tube with respect to the fixed bracket, and a controller controlling the first driver, the second driver, and the third driver.

18. The vehicle steering device of claim 17, further comprising a first sensor for sensing an axial position of the upper tube with respect to the lower tube,
wherein the wire assembly connects the first sensor and the controller.

19. The vehicle steering device of claim 17, further comprising a second sensor for sensing an axial position of the lower tube with respect to the fixed bracket,
wherein the wire assembly connects the second sensor and the controller.

20. The vehicle steering device of claim 17, further comprising a third sensor for sensing an angle of the lower tube from the fixed bracket,
wherein the wire assembly connects the third sensor and the controller.
